(19) United States
(12) Patent Application Publication
(10) Pub. No.: US 2017/0363001 A1
(43) Pub. Date: Dec. 21, 2017

(54) AIRCRAFT ENGINE SHIELD

(71) Applicant: MARVIN HILL, OCALA, FL (US)

(72) Inventor: MARVIN HILL, OCALA, FL (US)

(21) Appl. No.: 15/185,027

(22) Filed: Jun. 17, 2016

(51) Int. Cl. F02C 7/055; B64C 1/14; B64D 33/02

(52) U.S. Cl. CPC F02C 7/055; B64C 1/1484; F05D 2220/323; B64D 2033/022

(57) ABSTRACT

The present invention relates to aircraft engine shield placed over the front of the jet turbines and across the wind shield, made up of heavy duty metal or other suitable material to prevent bird strikes, having small air gaps which not only prevents birds from entry but also prevents any other external particle either small or large to enter the wind shield or front turbines which in turn protects the air craft from any problem,

### FIELD OF THE INVENTION

The present invention relates to aircraft engine and cockpit shield, a heavy-duty mesh that is added over the front of the jet turbines and across the windshield to prevent bird strikes.

### BACKGROUND OF THE INVENTION

Jet safety starts before the flight begins. The jets electrical and mechanical systems help ensure your safety in the sky, but they need routine care and structural safety components to keep them in tip-top shape whether it is a personal jet or a commercial airliner.

In addition to this, bird strikes are a significant threat to airplane safety, and have caused a number of accidents with many human casualties. The majority of bird strikes cause little damage to the aircraft. However, those that do damage aircraft can cause many deaths, especially when a passenger plane is involved. It is estimated that bird strikes caused up to $400 million of damage on planes being flown in the United States, even when these planes did not crash. Bird can be sucked in by the jet turbines, causing one or more of the engines to stop working, and they can hit the wind shield with such force that the glass cracks, impairing the vision of the pilots. Jet engine ingestion is extremely serious due to the rotation speed of the engine fan and engine design. As the bird strikes a fan blade, that blade can be displaced into another blade and so forth, causing a cascading failure. Jet engines are particularly vulnerable during the takeoff phase when the engine is turning at a very high speed and the plane is at a low altitude where birds are more commonly found.

Therefore, there remains a need to overcome above mentioned problems and in the present invention the above mentioned problems are solved.

### SUMMARY OF THE INVENTION

In order to solve above mentioned problem, the present invention provides an aircraft engine shield wherein, the aircraft engine shield is heavy-duty mesh that is added over the front of the aircraft turbines and across the aircraft wind shield to minimize damage in the event of any object including birds, stones, any substantive particle in the air, or the combination of these thereof. The possible materials used for the present invention are heavy duty metals, carbon fiber or any other suitable material. The present invention is either bolted or welded on the front of the aircraft turbines and across the aircraft wind shield.

Moreover, this shield is also placed in over the cockpit windshield to prevent the glass from cracking at the time of any bird attack or at the time of any unsafe thing approaching towards the air craft which in turn helps maintain the pilots and passengers' safety inside the aircraft,

### BRIEF DESCRIPTION OF THE DRAWINGS:

FIG. 1 is a close up view of the present invention placed over the front of the jet turbines according to an embodiment of the invention,

FIG. 2 is a perspective view of the present invention placed over the front of the cockpit windshield according to an embodiment of the invention.

### DETAIL DESCRIPTION OF THE DRAWINGS

An embodiment of the given invention is described in detail with the help of the given drawings, where all illustrations of the drawings are for the purpose of describing selected versions of the present invention and are not intended to limit the scope of the present invention:

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All publications, patents and patent computer implemented methods mentioned herein are incorporated herein in their entirety.

Herein, in the present invention object is been referred to bird, stones, any substantive particle existing in air or the combination of these thereof.

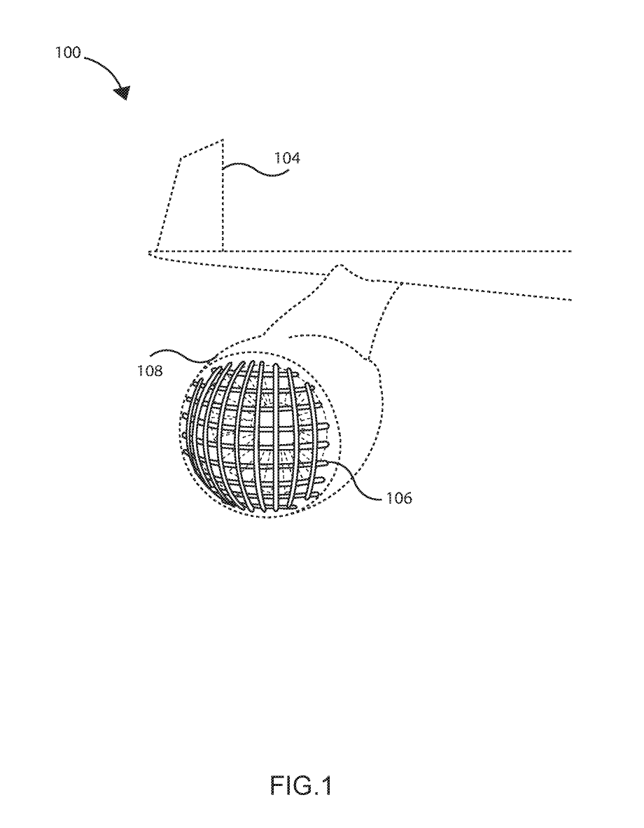

FIG. 1 is a close up view of the present invention placed over the front of the aircraft turbines according to an embodiment of the invention and illustrates a system 100, consists of an aircraft 104 with aircraft engine shield 106 placed over the front of the aircraft turbines 108, made up of heavy duty material to prevent any object strikes. Having small air gaps not only prevents birds entry but also prevent any other external particle of potentially damaging size to enter the jet turbines 108 which in turn protects the air craft 104 from any problem. Further, the aircraft engine shield 106 is made up of tungsten or similarly strong, rigid material.

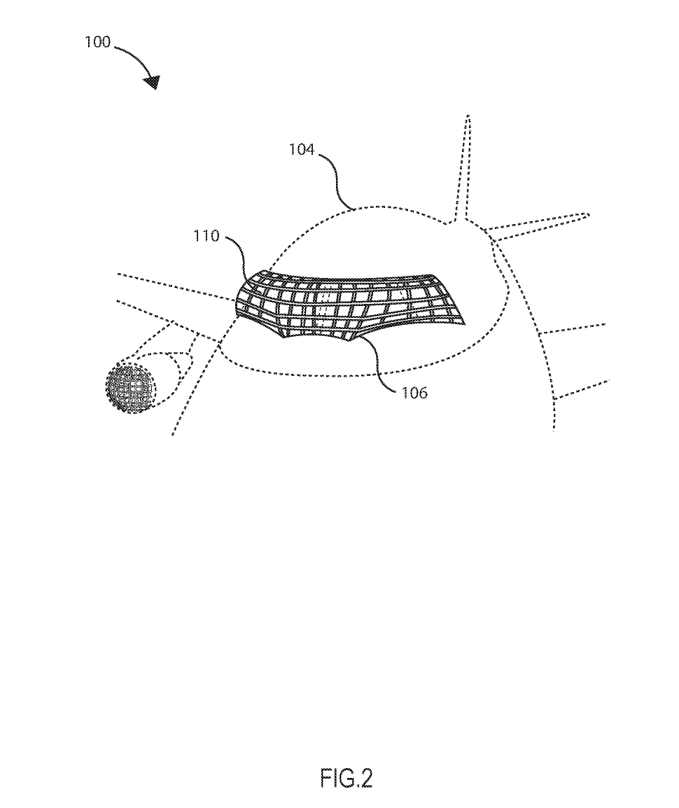

FIG.2 is a perspective view of the present invention placed over the front of the cockpit windshield according to an embodiment of the invention and illustrates a system 100, a aircraft engine shield 106 made up of heavy duty metal which is either bolted or welded over the aircraft wind shield 110 used by the pilot for viewing. Also, this aircraft engine shield 106 prevents the wind shield 110 from cracking by any object strike and in turn provides safety to the passengers and the pilots.

Although, the invention has been explained in relation to its preferred embodiment, it is to be understood that many other possible modifications and variations can be made without departing from the spirit and scope of the invention.

What is claimed is:

1. An aircraft shield, comprising of:
a) at least first protective mesh cover, coupled with at east one aircraft turbine and at least second protective mesh cover coupled with at least one aircraft windshield, wherein at least first protective mesh cover and at least second protective mesh cover prevent the damage caused by unnecessary collision of an object with the at least first protective mesh cover and at least second protective mesh cover.

2. The aircraft shield according to claim 1, wherein at least first protective mesh cover and at least second protective mesh cover are made up of at least one of tungsten, titanium, aircraft aluminum, carbon fiber or the combination of thereof.

3. The aircraft shield according to claim 1, wherein at least first protective mesh cover and at least second protective mesh cover is either bolted or welded with the aircraft turbine and the aircraft windshield respectively.

4. The aircraft shield according to claim 1, wherein the object includes at least one of a bird, a stone, any substantive particle in the air or the combination thereof.
